(19) United States
(12) Patent Application Publication
(10) Pub. No.: US 2005/0231468 A1
(43) Pub. Date: Oct. 20, 2005

(54) Methods and systems for interacting with virtual objects

(75) Inventors: Liang Chen, Prince George (CA); Charles Grant Brown, Whistler (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: University of Northern British Columbia, Prince George (CA)

(21) Appl. No.: 11/106,616

(22) Filed: Apr. 15, 2005

Related U.S. Application Data
(60) Provisional application No. 60/562,236, filed on Apr. 15, 2004.

(51) Int. Cl. G09G 5/00

(52) U.S. Cl. 345/156

(57) ABSTRACT

The invention provides an apparatus for interacting with a computer system comprising a processor coupled to a display. The apparatus comprises a body configured to be moveable by a user. The body has a position sensor therein for producing a main position signal. A plurality of probe members are connected to the body. A plurality of transducers are coupled to the probe members for producing probe motion signals representative of positions of the probe members. A plurality of actuators are coupled to the probe members to selectively apply force to the probe members. A control system is coupled to the position sensor, the transducers and the actuators for receiving the main position signal and the probe position signals and interacting with the processor in order to produce control signals for controlling each of the probe members.

### TECHNICAL FIELD

The invention relates to methods and systems for interacting with virtual objects in computer systems. Embodiments provide devices for facilitating interaction between users and three-dimensional virtual objects, and methods of using such devices.

### BACKGROUND

Virtual objects in computerized environments can be useful in a wide variety of applications. A virtual object may comprise, for example, a data model representing one or more surfaces in a three or more dimensional space. However, in order to manipulate such objects a user typically needs to be familiar with complicated software interfaces and/or input devices.

Noll (U.S. Pat. No. 3,919,691) discloses a three-dimensional tactile control unit including a position data generator and a force responsive unit.

Paley (U.S. Pat. No. 5,506,605) discloses a three-dimensional mouse comprising a generally vertically oriented housing with a mechanism in the housing for locating the mouse.

Rosenberg et al. (U.S. Pat. No. 6,366,272) disclose a method and apparatus for providing force feedback to a user operating a human/computer interface device and interacting with a computer-generated simulation.

Kramer et al. (U.S. Pat. No. 6,413,229) disclose an interface device comprising a force-generating device that produces a force which is applied to a sensing body part by a force-applying device.

There exists a need for methods and systems that allow users to interact with virtual objects stored in computer systems without requiring the users to familiarize themselves with complicated software interfaces or input devices.

### SUMMARY OF THE INVENTION

One aspect of the invention provides an apparatus for interacting with a computer system comprising a processor coupled to a display. The apparatus comprises a body configured to be moveable by a user. The body has a position sensor therein for producing a main position signal. A plurality of probe members are connected to the body. A plurality of transducers are coupled to the probe members for producing probe motion signals representative of positions of the probe members. A plurality of actuators are coupled to the probe members to selectively apply force to the probe members. A control system is coupled to the position sensor, the transducers and the actuators for receiving the main position signal and the probe position signals and interacting with the processor in order to produce control signals for controlling each of the probe members. The apparatus may also comprise a switch for selecting an operating mode of the apparatus.

Another aspect of the invention also provides a method of using such an apparatus for drawing a surface on a display connected to the processor. The method comprises receiving a reference plane, displaying a main pointer on the display at a location determined by the main position signal, displaying a probe pointer on the display for each probe member at a location determined by the probe motion signals, displaying a connector defined by a selected set of the probe pointers, and, drawing the surface by moving the connector in response to changes in the main position signal and the probe motion signals, the surface comprising an area swept out by the connector.

Further aspects of the invention and features of various embodiments of the invention are set out below.

### BRIEF DESCRIPTION OF DRAWINGS

In drawings which illustrate non-limiting embodiments of the invention:

FIG. 1 schematically depicts a computer system according to one embodiment of the invention;

FIG. 2 illustrates an input/output device for use with the system of FIG. 1;

FIG. 3 schematically illustrates the control system of the input/output device of FIG. 2;

FIG. 4 illustrates a probe connection which couples a probe member to the body of the input/output device according to one embodiment of the invention;

FIG. 5 is a flowchart illustrating steps in a method according to one embodiment of the invention;

FIG. 6 illustrates the display of FIG. 1 with a reference plane and pointers displayed thereon;

FIG. 7 illustrates the display of FIG. 6 whereupon a user is drawing a surface;

FIG. 8 illustrates a method of modifying a surface according to another embodiment of the invention;

FIG. 9 illustrates a probe connection which couples a probe member to the body of the input/output device according to another embodiment of the invention;

FIGS. 10A-D illustrate the operation of a system according to one embodiment of the invention;

FIG. 11 illustrates an input/output device according to another embodiment of the invention;

FIG. 12 illustrates a probe connection according to another embodiment of the invention;

FIG. 13 illustrates an input/output device according to another embodiment of the invention;

FIG. 14 schematically illustrates the control system of the input/output device of FIG. 13; and,

FIG. 15 illustrates a state machine which controls operation of firmware according to one embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

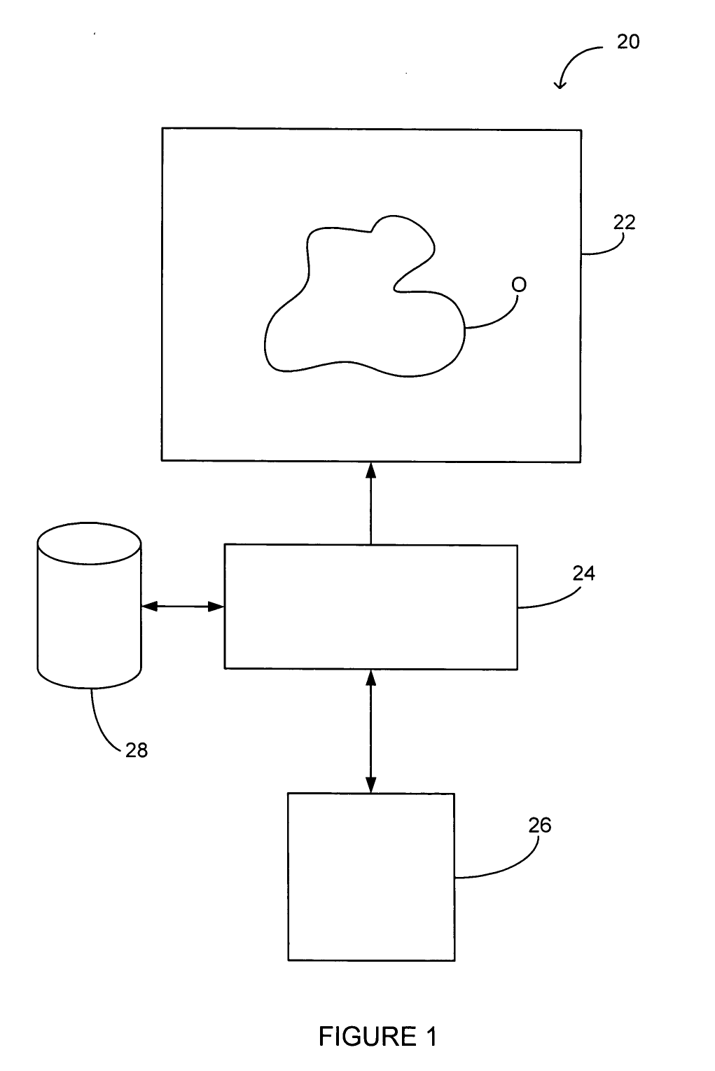

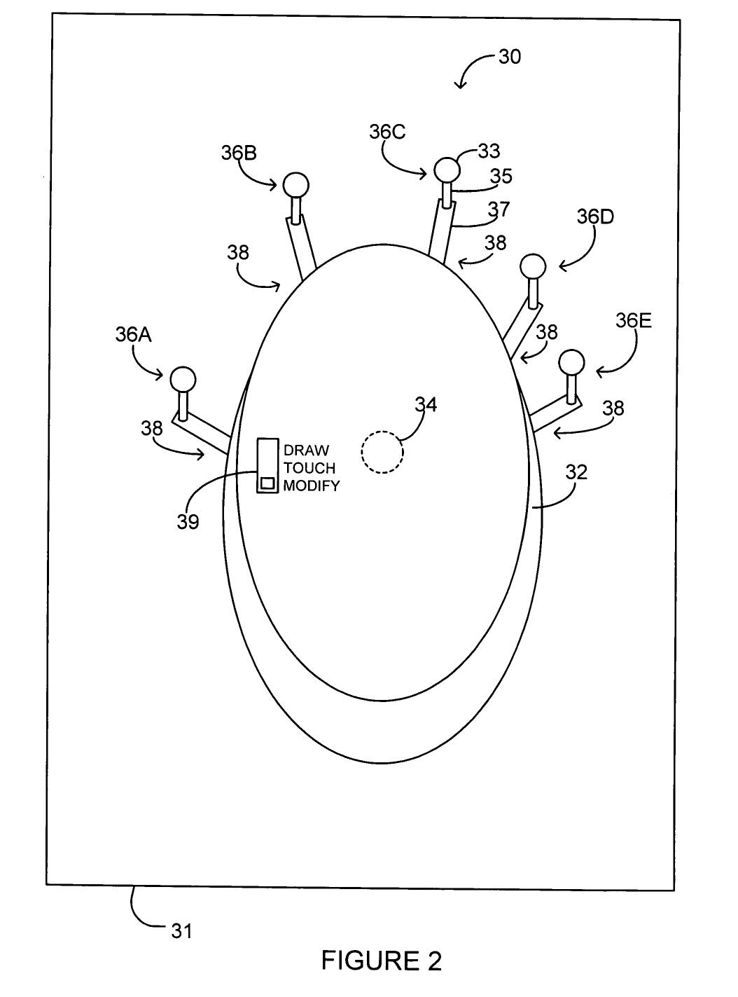

FIG. 1 illustrates a computer system 20 according to one embodiment of the invention. System 20 comprises a display 22 connected to a processor 24. Processor 24 typically comprises memory with computer readable instructions embodied therein which enables a user to interact with a virtual object O displayed on display 22 by means of a user interface 26 connected to processor 24. Processor 24 may also be connected to an external device 28. Device 28 may comprise another computer system, a data store, a modem for connecting to a local area network or the Internet, or the like. In the FIG. 1 embodiment, user interface 26 comprises an input/output device 30, as shown in FIG. 2. User interface 26 may also comprise a standard keyboard and mouse.

In one embodiment, device 30 allows a user to create and interact with virtual objects in an intuitive manner by providing tactile feedback to the user. Device 30 comprises a position sensor and can be moved by the user to generate a position signal, similar to the signals generated by a mouse, trackball, joystick, or the like. Device 30 also comprises a plurality of probe members which are independently movable by the user to define a group of points in virtual space. The points may be used to generate a curve (e.g. by fitting a curve to points using any suitable fitting algorithm). The user can create a virtual surface by arranging the probe members along a curve which fits a profile of the desired surface and selecting DRAW mode, which forms a virtual “connector” fit to the curve defined by the probe members. The user then moves device 30 to “sweep out” the surface with the connector.

The surface may be stored as a data model in a memory of processor 24, and used to form part of a virtual object. The user can feel the contours of an existing virtual surface by selecting TOUCH mode and moving device 30 about a work area such as a desktop or mouse pad, which causes the probe members to be adjusted by processor 24 to correspond to the virtual surface. The user can modify an existing virtual surface by selecting MODIFY mode and moving device 30 about the work area and selectively applying pressure to the probe members so that the probe members reach the positions desired by the user.

FIG. 2 illustrates an input/output device 30 according to one embodiment of the invention. Device 30 may be coupled to processor 24 by wired or wireless means. Device 30 comprises a body 32, a position sensor 34, and a plurality of probe members 36 which are adjustably attached to body 32 by means of probe connections 38. Device 30 is moveable on a flat surface 31, with probe members 36 positioned at an adjustable height above the level of the flat surface 31. In some embodiments, position sensor 34 comprises a pose sensor which generates signals representative of the position and orientation of body 32. For example, the pose sensor could comprise a pair of position sensors, a camera for viewing flat surface 31 to determine the orientation of body 32, or any other suitable apparatus for generating orientation information.

Device 30 may also comprise a mode selector switch 39 on body 32 for selecting an operating mode of system 20, as described further below. Alternatively, the mode of operation of system 20 may be selectable by means of software running on processor 24. System 20 may operate in DRAW mode for allowing the user to create virtual objects, in TOUCH mode for allowing the user to feel virtual objects, and in MODIFY mode for allowing the user to alter virtual objects. System 20 may also optionally be provided with additional modes for calibrating device 30, or to disable the DRAW, TOUCH and MODIFY modes such that device 30 acts like a standard mouse.

Position sensor 34 and probe connections 38 are operatively coupled to a control system 40 (not shown in FIG. 2). In the FIG. 2 embodiment, device 30 comprises five probe members 36A to 36E, each corresponding to one of a user's thumb and fingers, although it is to be understood that a different number of probe members 36 could be used. In the embodiment of FIG. 2, each probe member 36 comprises a touch pad 33 atop a vertical shaft 35, connected to an arm 37 which is in turn connected to body 32 by probe connection 38. The position of probe members 36 with respect to each other and body 32 is adjustable by means of probe connections 38.

Probe connections 38 enable the height h of each probe member above flat surface 31 to be controllably adjusted. In some embodiments, probe connections 38 provide one degree of freedom in the motion of probe members 36 with respect to body 32. For example, probe connections could allow probe members to move vertically with respect to flat surface 31, or could allow each probe member to pivot in a plane perpendicular to flat surface 31 and parallel to arm 37 for that probe member 36. Probe connections 38 may alternatively provide two or three degrees of freedom, for example by allowing arms 37 to move inwardly and outwardly with respect to body 32, and/or by allowing arms 37 to pivot in a plane parallel to flat surface 31. While various mechanisms are illustrated herein to provide examples of possible configurations of probe connections 38, it is to be understood that these examples are included for illustrative purposes only, and other configurations of probe connections 38 are possible within the scope of the invention.

The position of each probe member 36 with respect to body 32 may be expressed as (r, θ,h), wherein r represents the distance of pad 33 of probe member 36 from body 32, θ represents the angle of a projection of arm 37 of probe member within a plane parallel to the flat surface 31 upon which body 32 moves, and h is the height of pad 33 over flat surface 31. Alternatively, in some embodiments it may be preferable to express the position of probe members 36 with respect to body 32 in terms of Cartesian coordinates (x,y,h), wherein x represents the left/right position of pad 33 of probe member 36 and wherein y represents the forward/backward position of pad 33, or spherical coordinates (r, θ, φ) wherein φ represents the angle of arm 37 of probe member 36 with respect to flat surface 31. As will be understood by one skilled in the art, conversion between (r, θ,h), (x,y,h) and (r, θ, φ) may be readily accomplished by suitable mathematical transformations.

In some embodiments, the relative position of probe members 36 may be customized to fit a user's preference. For example, a user may move each probe member 36 to a desired position in r and θ (or x and y) before using device 30. The user may then lock r and θ (x and y) while using device 30, while allowing the height h of pads 33 to vary, for any or all probe members 36. In other embodiments, the motion of probe members 36 within one or more degrees of freedom may be selectively constrained to be within a certain range, depending on the user's preference.

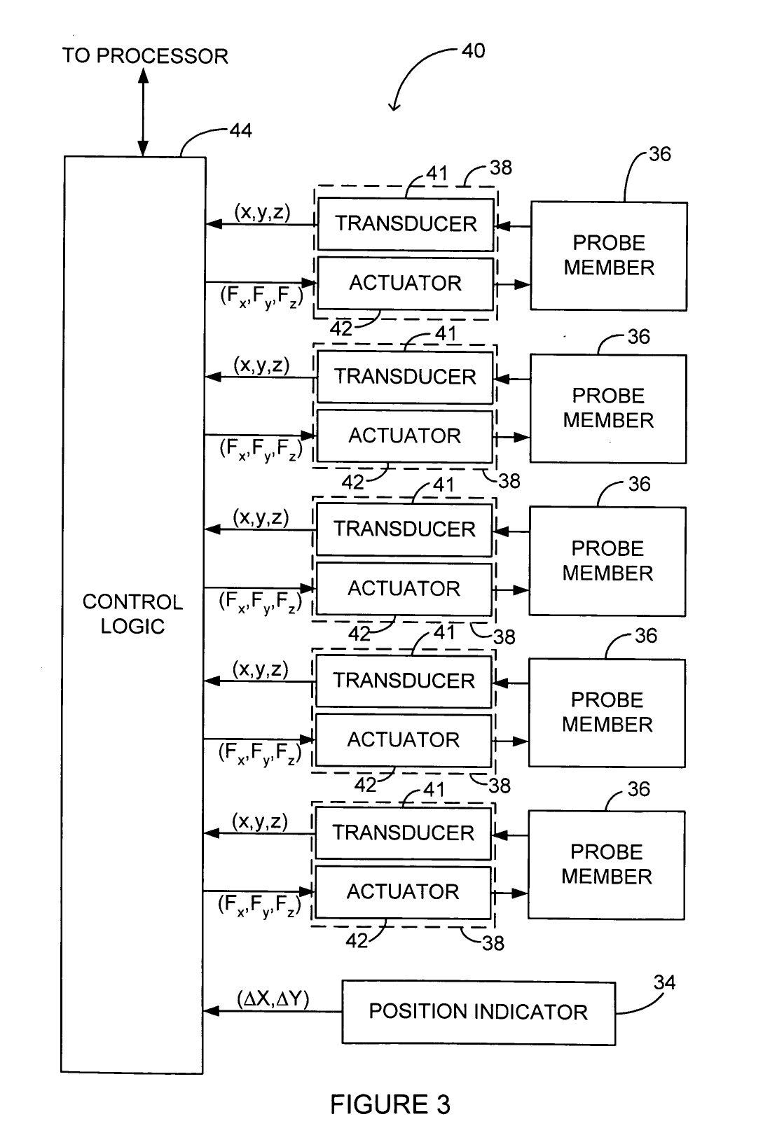

FIG. 3 schematically illustrates a control system 40 by means of which device 30 interacts with processor 24 according to one embodiment of the invention. Control system 40 is configured to receive information about the position or position and pose of device 30 from position sensor 34, and to convert the relative positions of probe members 36 with respect to body 32 into electrical, optical or other signals, and to receive control signals from processor 24 in order to adjust the positions of, and/or force applied to, probe members 36. In the embodiment of FIG. 3, control system 40 comprises a control logic 44, which is connected to processor 24. Alternatively, control logic 44 may be embodied in software running on processor 24.

Position sensor 34 is coupled to provide control logic 44 with a main position signal indicative of the position of device 30 on the flat surface 31. The main position signal may be similar to the signals generated by a prior art mouse, trackball, or the like, and may be expressed in Cartesian coordinates as (ΔX,Y), or in any other suitable coordinate system, such as polar coordinates. Alternatively, in embodiments where position sensor 34 includes a pose sensor, the main position signal could comprise a pose signal which includes information about the orientation of device 30. This allows the user to rotate device 30 while moving it to touch or modify a surface, or in order to sweep out a curved surface, as described further below.

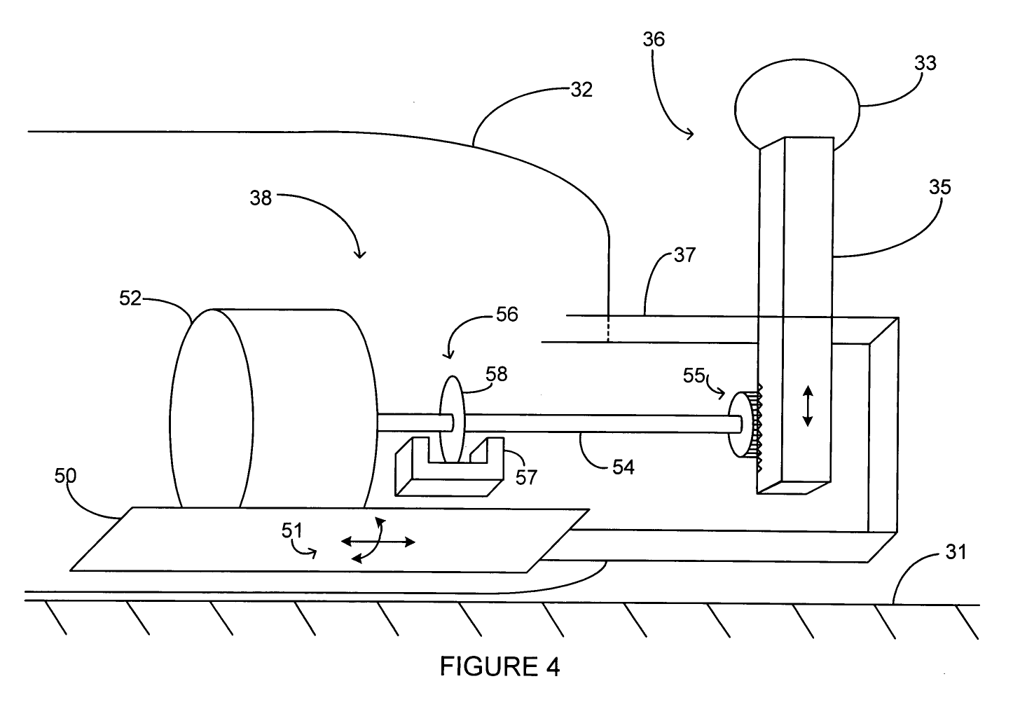

Each probe member 36 is coupled to a probe connection 38 comprising a transducer 41 and an actuator 42, which are in turn coupled to control logic 44. While transducer 41 and actuator 42 are shown as separate elements in FIG. 3, it is to be understood that a single device could provide the functionality of these two elements. Each transducer 41 provides control logic 44 with a probe motion signal indicative of the motion of the associated probe member 36 with respect to the main position. The probe motion signal may be expressed in any suitable coordinate system, as discussed above. In embodiments wherein only a single degree of freedom is provided for each probe member 36, such as the example illustrated in FIG. 4 and described below, the probe motion signals may each comprise a single value corresponding to the associated probe member's displacement in that degree of freedom (i.e., the vertical direction in the FIG. 4 embodiment).

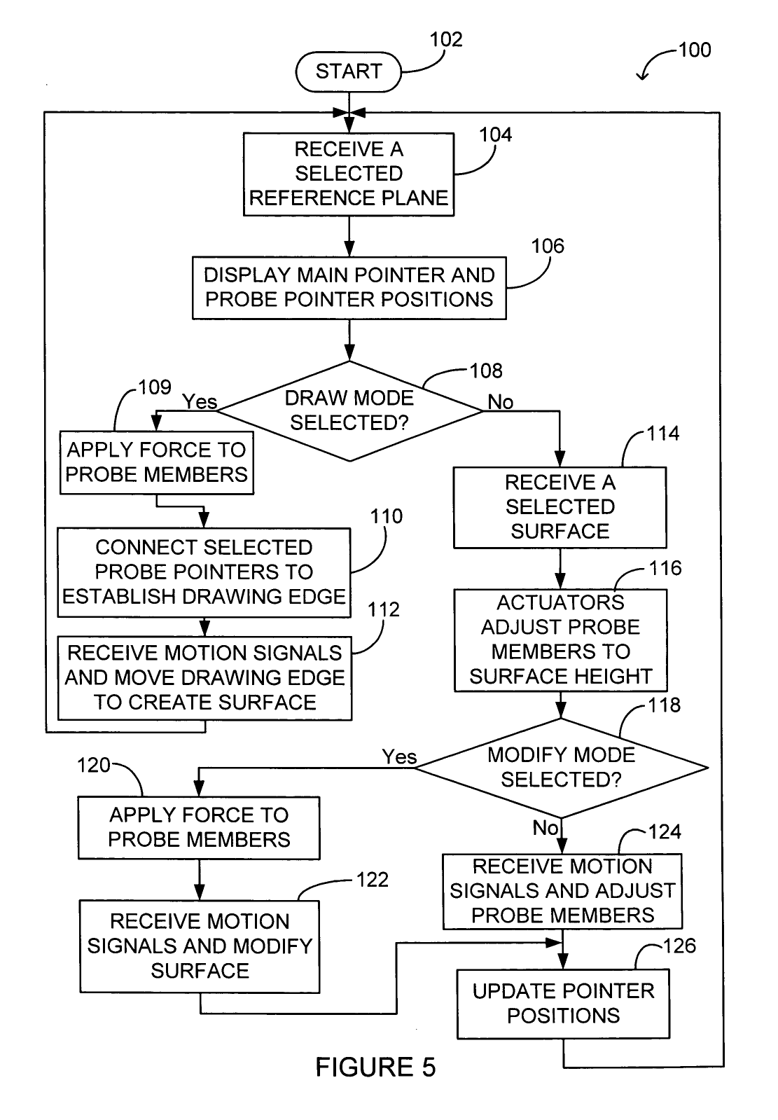

Control logic 44 calculates probe positions from the probe motion signals and provides main position and probe positions to processor 24. When system 20 is in DRAW mode, processor 24 uses the main position and probe positions to draw a virtual surface on display 22. When system 20 is in TOUCH or MODIFY mode, control logic 44 receives information about a user selected virtual surface from processor 24 and provides control signals to actuators 42. The operation of system 20 in each of the DRAW, TOUCH and MODIFY modes is described further below with reference to FIG. 5.

FIG. 4 illustrates a probe connection 38 according to one embodiment of the invention which provides the associated probe member 36 with one degree of freedom while device 30 is in use. In the FIG. 4 embodiment, probe connection 38 comprises a base 50 to which arm 37 of probe member 36 is connected. Base 50 is adjustable, as indicated by arrows 51, to allow arm 37 of probe member 36 to be pivoted and extended with respect to body 32. A user adjusts base 50 to move probe member 36 into a comfortable position prior to using device 30. Arm 37 passes through an aperture (not shown) in body 32 which is wider than arm 37 to accommodate movement of base 50 with respect to body 32.

A rotary actuator 52 is coupled to base 50 and connected to turn a drive shaft 54. Base 50 and rotary actuator 52 are preferably under control of a control system similar to control system 40 of FIG. 3 (not shown in FIG. 4). Drive shaft 54 is coupled to vertical shaft 35 by means of a rack and pinion 55 to allow adjustment of the height h of pad 33 of probe member 36. An angular displacement transducer 56 is coupled to drive shaft 54 to provide the control system with a signal representative of the height h of pad 33 of probe member 36 with respect to surface 31. In the FIG. 4 embodiment, angular displacement transducer 56 comprises an optical angular displacement transducer comprising an optical sensor 57 and an optical chopper wheel 58. Any suitable angular displacement transducer, such as a mechanical angular displacement transducer, could be used.

It is to be understood that the FIG. 4 embodiment is only one example of the many possible configurations of probe connections 38. For example, each probe connection 38 could comprise a solenoid, a spring-like material which expands and contracts depending on an amount of current passed therethrough, a combination of levers and pivots, an auger-like arrangement with probe member 36 threadedly engaged by a vertical shaft coupled to a rotary actuator, or any suitable mechanism which can selectively apply force in at least one degree of freedom to the associated probe member 36 while device 30 is in use.

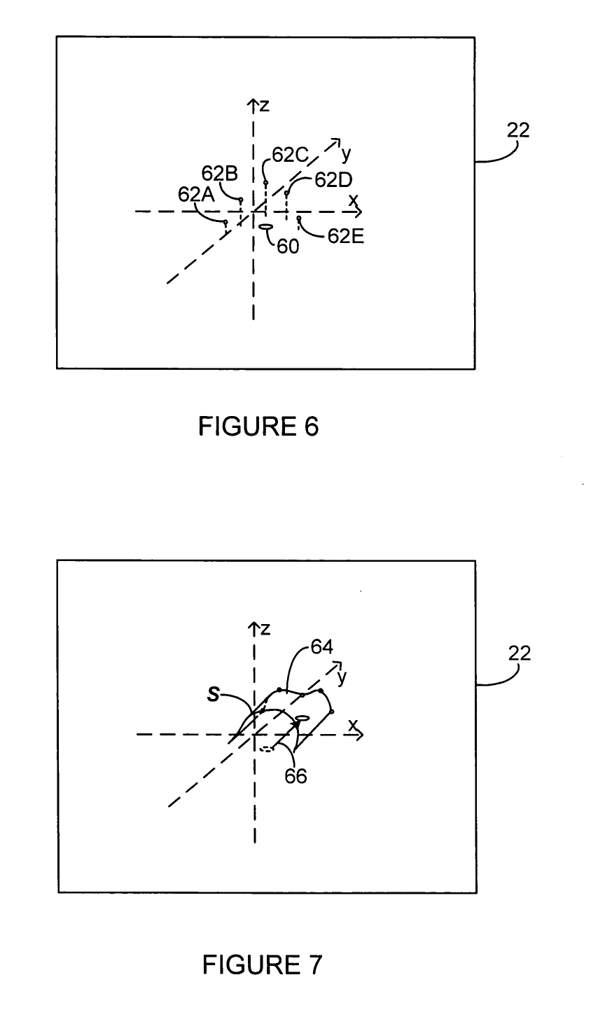

FIG. 5 illustrates a method 100 according to one embodiment of the invention. Method 100 is described herein with reference to system 20 of FIG. 1, device 30 of FIG. 2 and control system 40 of FIG. 3, but it is to be understood that method 100 could be adapted for use with systems according to other embodiments of the invention. Once method 100 begins at block 102, processor 24 receives a selected reference plane P_{ref} at block 104, which comprises a mathematical construct representing the flat surface 31 on which device 30 moves. The orientation of P_{ref} with respect to a virtual object stored in the memory of processor 24 and displayed on display 22 may be selected by the user. P_{ref} may, for example be selected to be the plane of the screen of display 22, or to be at an angle to the plane of the screen, like the x-y plane in FIG. 6. Selection of reference plane P_{ref} may be accomplished by means of a suitable software interface. In some embodiments, system 20 allows the user to hold device 30 stationary and move reference plane P_{ref} relative to device 30 with a software interface, trackball, keyboard, or other suitable means, as described further below.

At block 106, processor 24 displays a main pointer 60 on P_{ref} and a probe pointer 62 for each probe member 36 at a distance above (the positive z direction in FIG. 6) P_{ref} proportional to the distance that the probe member 36 is above the flat surface 31. The scale of the image on the screen in relation to the positioning of device 30 and probe members 36 is preferably adjustable by means of the software interface. FIG. 6 illustrates an example wherein the probe pointers 62A-62E are displayed along an arc above main pointer 60.

At block 108, processor 24 determines if switch 39 is in the DRAW position (or, in embodiments which lack switch 39, if the user has selected DRAW mode by means of a software interface). If it is, method 100 proceeds to block 109, where processor 24 causes control system 40 to send control signals to actuators 42 in order to apply an upward force F to each of the probe members. In DRAW mode, force F is preferably constant, with a magnitude such that the height hₚ of each probe member 36 above flat surface 31 will increase if no pressure is applied to that probe member 36, will remain unchanged when a user's finger or thumb rests atop that probe member 36, and will decrease when a user applies pressure to that probe member 36.

After applying force F at block 109, method 100 proceeds to block 110 where processor 24 displays a connector 64 defined by the probe pointers 62 of a selected set of probe members 36, as shown in FIG. 7. In some embodiments each probe pointer 62 comprises a point, and connector 64 is defined with respect to the points. While the connector 64 shown in FIG. 7 is defined by all of the probe pointers 62A-62E, it is to be understood that a user may specify which of the probe pointers 62 to use to define connector 64. The connector 64 may comprise line segments between the probe pointers 62, a smooth curve, or a combination of line segments and curves. The shape of connector 64 may be selected by a suitable software interface, and may be a spline curve by default.

At block 112 processor 24 receives motion signals from device 30, and draws a surface S swept out by the connector 64. The motion signals comprise signals from position sensor 34 and transducers 41. In embodiments such as the example illustrated in FIG. 4, wherein only a single degree of freedom is provided for each probe member 36, the signals from transducers 41 may each comprise a single value corresponding to the associated probe member's displacement in that degree of freedom (i.e., the z direction in the FIG. 4 embodiment). In embodiments wherein two or three degrees of freedom are provided for each probe member 36, the signals from transducers 41 are representative of the associated probe member's displacement in those degrees of freedom. In some such embodiments, the user may increase the length of connector 64 by spreading their fingers. In embodiments wherein position sensor 34 comprises a pose sensor, the orientation of connector 64 with respect to surface S may be controlled by controlling the pose of device 30.

After drawing the surface at block 112, method 100 returns to block 104 and repeats the steps performed at blocks 104 to 112 while switch 39 remains in the DRAW position. Each iteration of the steps in blocks 104 to 112 typically occurs very quickly in relation to the speed at which a user moves device 30, such that many iterations are required to draw a surface. The step of receiving the reference plane in block 104 may be omitted when the reference plane has already been received and it is not being changed by the user.

In the example illustrated in FIG. 7, surface S has been created by moving device 30 in the positive y direction, as indicated by arrow 66, and by the user depressing probe member 36C which corresponds to their middle finger. During creation of surface S of FIG. 7, method 100 may go through many iterations of the steps of blocks 104 to 112.

If switch 39 is not in the DRAW position, method 100 proceeds to block 114, where processor 24 receives a selected surface and indicates the selected surface on display 22. Indicating the selected surface may, for example, comprise highlighting the selected surface. The user may select the surface by means of a suitable software interface. The user can “zoom” in and out by selecting the size of the selected surface, so that the surface can be modified at different levels of detail. At block 116, processor 24 causes control system 40 to send control signals to actuators 42 in order to move each of probe members 36 to a height above the flat surface 31 proportional to the distance between the selected surface and P_{ref} at the projections of the probe pointers on P_{ref}.

At block 118, processor 24 determines if switch 39 is in the MODIFY position. If it is, method 100 proceeds to block 120, where processor 24 causes control system 40 to send control signals to actuators 42 in order to apply an upward force F to each of the probe members. For each probe member 36, force F has a magnitude which depends on a normalized height hₚ of probe member 36 above flat surface 31 and a normalized distance zₛ between the selected surface and P_{ref} at the projection of the associated probe pointer 62 on P_{ref}. The normalized height hₚ and normalized distance zₛ may be controlled by a suitable software interface, so that the user can select the amount of motion of a probe member 36 required to produce a desired change of position of the associated probe pointer 62.

Force F may be, for example, a constant k₁ when hₚ≧zₛ, and a slightly larger constant k₂ when hₚ<zₛ. Force F is preferably selected so that, when a small pressure with a magnitude k₁ is applied to probe members 36 (e.g. the pressure which may result from a user's fingertips resting on probe members 36) the probe members 36 are held at hₚ=zₛ, when no pressure (or a pressure less than k₁) is applied to probe members 36 the probe members 36 move up to hₚ>zₛ, and so that probe members 36 may be moved down to hₚ<zₛ by application of a pressure greater than k₂ to probe members 36 by the user. In some embodiments, force F may be user selectable, or may vary differently with hₚ and zₛ depending on the type of surface being modified. For example, virtual object O may comprise different types of surfaces: some which may not be modified, some which are “soft”, in that only a small amount of pressure is required to make hₚ<zₛ, and some which are “hard”, in that a larger amount of pressure is required to make hₚ<zₛ. For another example, force F may be a function of hp, or a function of the difference between hₚ and zₛ.

At block 122 processor 24 receives motion signals from device 30 and modifies the selected surface so that hₚ=zₛ. The motion signals comprise signals from position sensor 34 and transducers 41. Once the selected surface has been modified, method 100 proceeds to block 126 where the position of main and probe pointers 60 and 62 are updated. Method 100 then returns to block 104 and repeats the steps performed at blocks 104 to 108, 114 to 122 and 126 while switch 39 remains in the MODIFY position. The steps of receiving the reference plane in block 104 and receiving the selected surface in block 114 may be omitted when the reference plane and selected surface have already been specified and are not being changed by the user.

If switch 39 is not in the MODIFY position (i.e., it is in the TOUCH position; block 118, NO output) method 100 proceeds to block 124 where processor 24 receives motion signals from device 30 and adjusts the probe members 36 so that hₚ=zₛ, then proceeds to block 126 and updates the main and probe pointer positions 60 and 62 on display 22. The motion signals comprise signals from position sensor 34 and transducers 41. Alternatively, the user could hold device 30 stationary and “feel” the virtual surface by causing the surface to move relative to main pointer 60 and probe pointers 62. The virtual surface may be moved in one or two dimensions by means of a suitable software interface, and the motion of the virtual surface may be displayed on display 22 to provide visual feedback. Method 100 then returns to block 104 and repeats the steps performed at blocks 104 to 108, 114 to 118, 124 and 126 while switch 39 remains in the TOUCH position. The steps of receiving the reference plane in block 104 and receiving the selected surface in block 114 may be omitted when the reference plane and selected surface have already been specified and are not being changed by the user.

Preferably, method 100 returns to block 108 any time switch 39 changes positions. Also, a user may preferably cause method 100 to return to block 104 at any time by selecting a new reference plane P_{ref} by means of a suitable software interface.

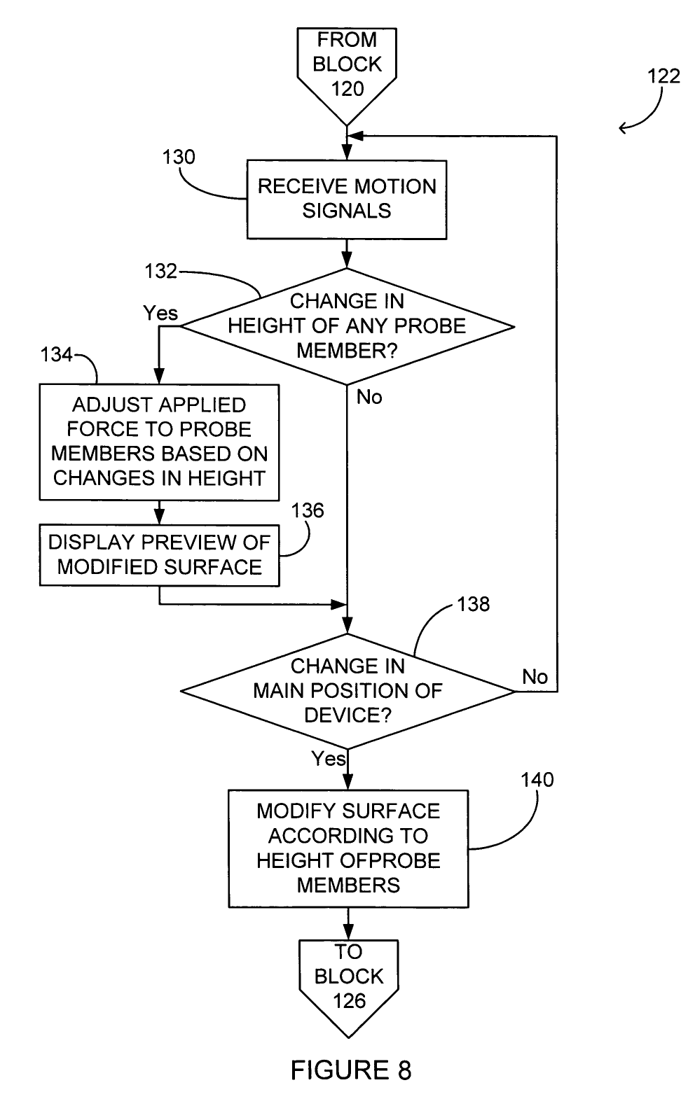

FIG. 8 illustrates an example of operation of method 100 at block 122 in an embodiment wherein the x and y positions of probe members 36 with respect to body 32 are held constant while device 30 is in use, such as the example embodiment of FIG. 4. At block 130, processor 24 receives motion signals from device 30. At block 132, processor 24 determines whether the height hp of any probe member 36 has changed. If so (block 132 “Yes” output), processor 24 causes actuators 42 to adjust the force F applied to the associated probe members 36 at block 134, and causes display 22 to show a preview of the modified surface at block 136. Once the preview is displayed, or if the probe members' 36 heights have not changed (block 132 “No” output), at block 138 processor 24 determines if the main position of device 30 has changed (as indicated by position sensor 34). If it has not (block 138 “No” output), method 100 returns to block 130. If the main position has changed (block 138 “Yes” output), at block 140 processor 24 modifies the surface according to the heights of probe members 36, and then method continues to block 126, as discussed above.

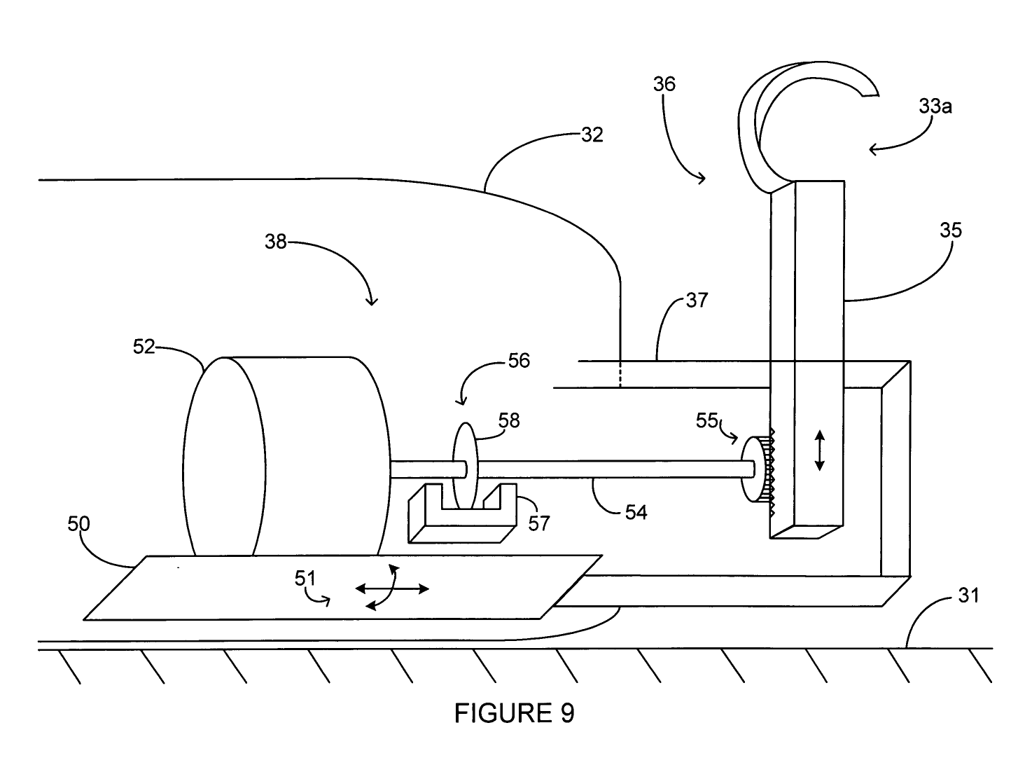

FIG. 9 illustrates another embodiment of the probe member 36 of the example embodiment of FIG. 3. In the FIG. 9 embodiment, pad 33 of probe member 36 has been replaced with a finger loop 33a. The rest of the FIG. 9 embodiment is the same as the FIG. 3 embodiment. The FIG. 9 embodiment eliminates the need for the small constant upward force in DRAW mode, and in MODIFY mode when hₚ≧zₛ, since the user may raise the height of probe member 36 by means of finger loop 33a. However, the upward force in MODIFY mode when hₚ<zₛ will still be required in the FIG. 9 embodiment to provide tactile feedback to the user, and so that probe member 36 moves upwards toward hₚ=zₛ when the user does not place a force on the probe.

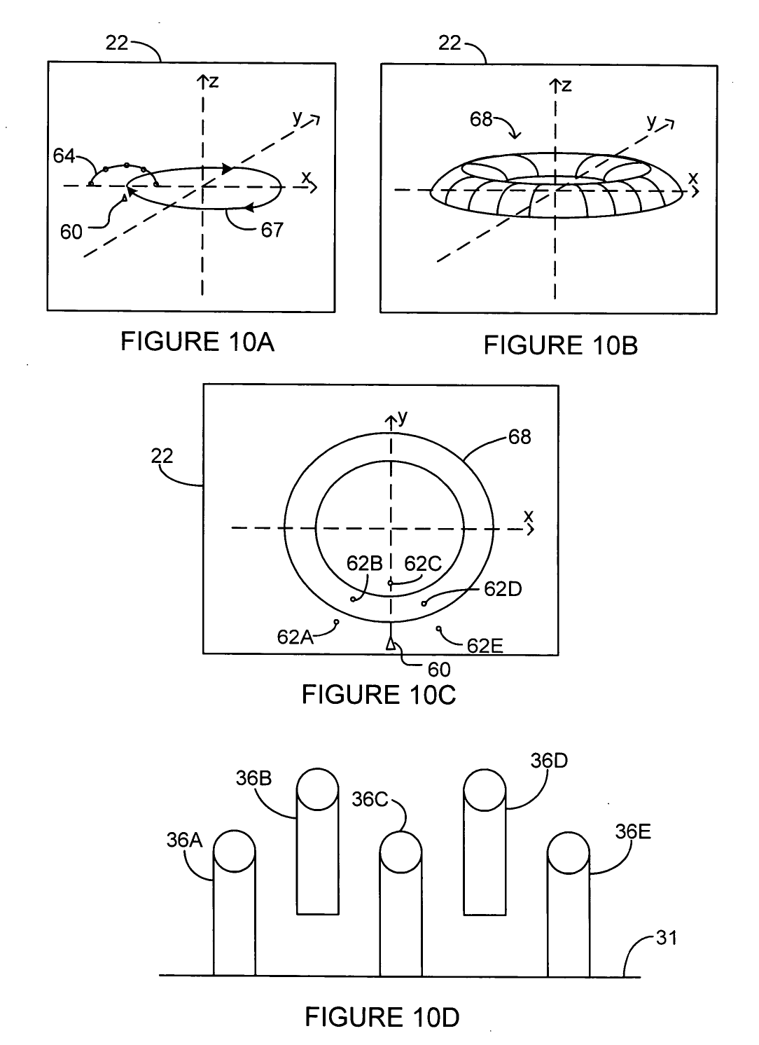

FIGS. 10A-D illustrate examples of operation of certain embodiments of system 20 according to the invention. As shown in FIG. 10A, the user begins by arranging probe members 36 (and thereby probe pointers 62) in an arc, and placing system 20 in DRAW mode which causes processor 24 to display connector 64. The user can then use system to create a surface 68 comprising an annular bulge, as shown in FIG. 10B, in a number of different ways, depending upon the configuration of system 20. In the examples described below, it is to be understood that creation of surface 68 comprises causing relative motion between device and the reference plane which generates motion signals which are provided to processor 24, which in turn moves main pointer 60, probe pointers 62 and connector 64 in the virtual world, and displays the surface swept out by connector 64 on display 22.

Some embodiments do not have a pose sensor but do have a position sensor. In such embodiments the user can move device 30 in a circular motion as indicated by arrows 67 in FIG. 10A, while maintaining the orientation of body 32 and changing the position of probe members 36 (including their height h) relative to body 32, to create surface 68. Changing the position of probe members 36 relative to body 32 may optionally comprise providing a platform which is pivotally coupled to body 32 upon which all of the probe connections 38 of probe members 36 are mounted. Alternatively, the user could cause the reference plane to rotate about the z-axis while holding device 30 stationary to create surface 68. The reference plane could be moved, for example, by moving a trackball, using the cursor keys of a keyboard, or by specifying a path for the plane to follow using the software interface.

In other embodiments position sensor 34 comprises a pose sensor which provides information about the orientation of body 32 to processor 24. The orientation information is indicated on display 22 by an appropriately shaped main pointer 60, and connector 64 maintains a position with respect to main pointer 60 which corresponds to the position of probe members 36 with respect to body 32. In such embodiments, the user could create surface 68 of FIG. 10B by turning body 32 to follow the circular path indicated by arrows 67. Alternatively, a user may sweep out half of the circular path, switch system 20 into TOUCH mode and reorienting device 30, and then return system 20 to DRAW mode and sweep out the other half of the circular path, in such embodiments.

Once surface 68 has been created, the user can adjust system 20 using the software interface so that the reference plane (which is the x-y plane in the illustrated example) is parallel to the screen of display 22. The user then places system 20 in TOUCH mode and moves device 30 so that probe pointers 62A-62E are positioned over surface 68, as shown in FIG. 10C. The positioning of probe pointers 62A-62E shown in FIG. 10C while system 20 is in TOUCH mode causes processor 24 to adjust the heights of probe members 36A-36E as shown schematically in FIG. 10D.

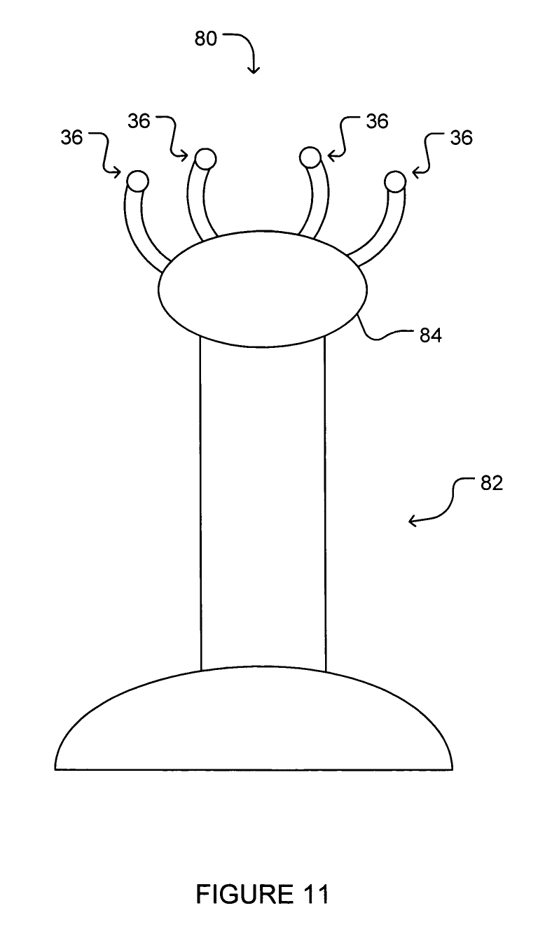

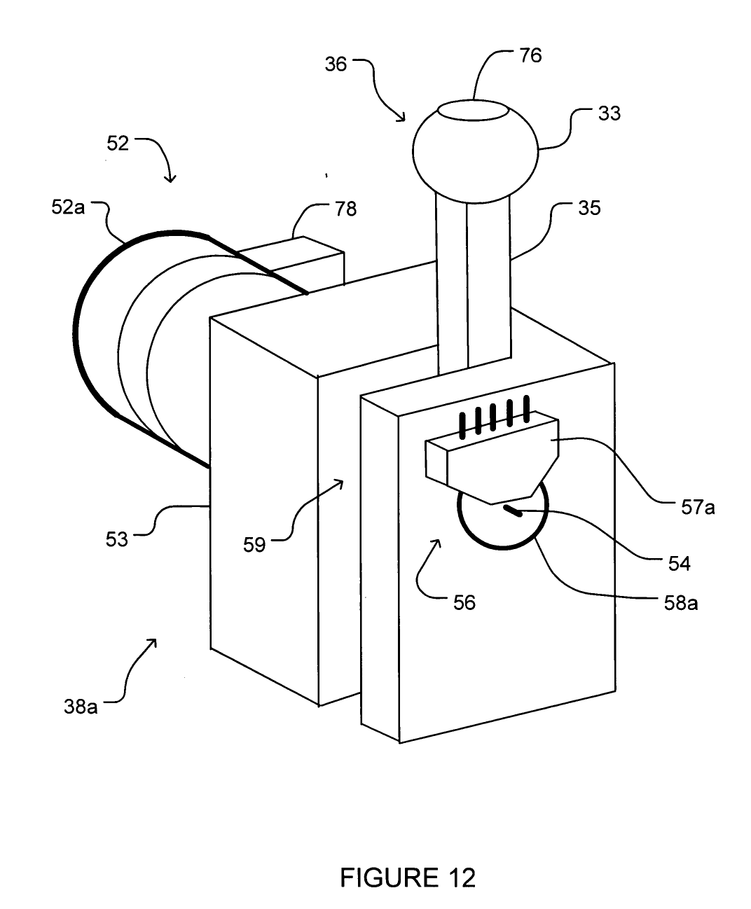

FIG. 11 illustrates an input/output device 70 according to another embodiment of the invention. Device 70 comprises a joystick 72 with a plurality of probe members 36 extending outwardly from the top 74 thereof. Device 70 functions similarly to device 30 of FIG. 2, with the main difference being that position sensor 34 of device 30 is not required, as the user may cause main pointer 60 to move by means of joystick 72.

FIG. 12 shows probe connection 38a according to another embodiment of the invention. Probe connection 38a comprises a block assembly 53 with a slot 59 therein for receiving shaft 35 of probe member 36. Rotary actuator 52 comprises a motor 52a on one side of block assembly 53. In some embodiments, motor 52a comprises a stepper motor having two windings. The amount of force applied to each probe member 36 may be controlled by controlling the current provided to each motor 52a. Angular displacement transducer 56 is on the other side of block assembly 53 from motor 52a, and comprises a quadrature sensor 57a, and a code wheel 58a.

In the FIG. 12 embodiment, probe member 36 comprises an optional pressure switch 76 atop pad 33. Pressure switch 76 is configured to cause rotary actuator 52 to reduce the upward force exerted on probe member 36 when triggered, such that probe member 36 may be pushed down. In some embodiments, pressure switch 76 may disable rotary actuator 52 when triggered, and a resistive upward force on probe member 36 may be provided by a suitable arrangement of permanent or electro-magnets, or by elastic devices.

Pressure switch 76 may be triggered by a user exerting a predetermined downward force thereon. For example, a downward force of at least k₂ may be required to trigger pressure switch 76. Alternatively, rotary actuator 52 may be provided with a torque sensing device 78 which reduces the upward force exerted on probe member 36 when the torque on rotary actuator 52 exceeds a threshold which corresponds to the predetermined downward force.

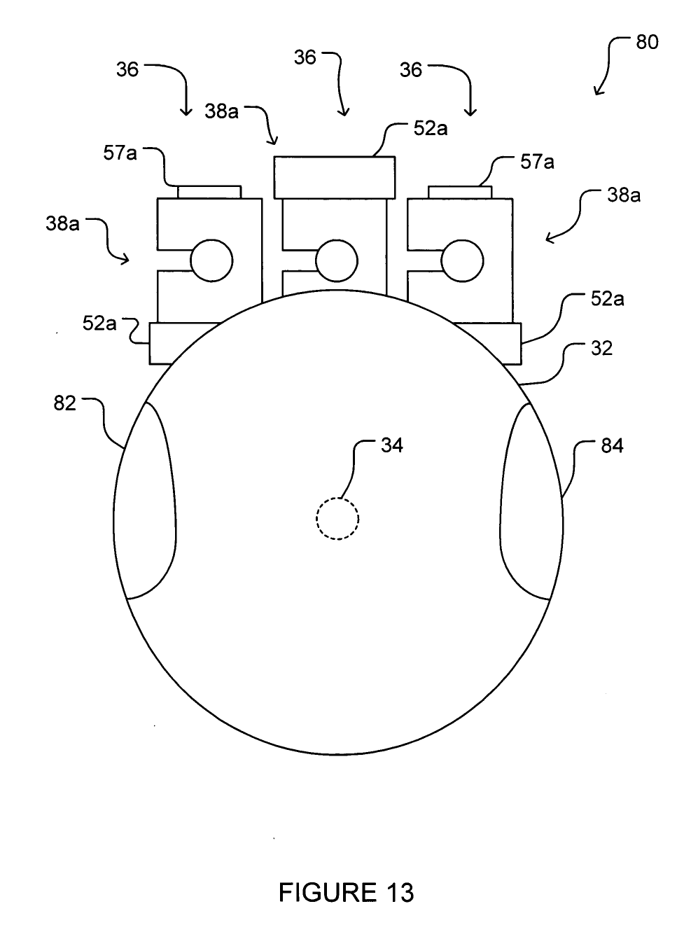

FIG. 13 shows a device 80 according to another embodiment of the invention. Device 80 is similar to device 30 of FIG. 2, except that device 80 has only three probe members 36, and lacks mode selector switch 39. The mode of device 80 may be controlled, for example, by software running on a computer system (not shown) to which device 80 is connected. Also, device 80 comprises left and right mouse buttons 82 and 84, respectively, such that device 80 may perform the functions of a standard mouse. Probe members 36 of device 80 are connected to body by means of probe connections 38a as shown in FIG. 12. A middle one of probe connections 38a has motor 52a on an outer end thereof, and the outer probe connections 38a have motors 52a on the inner ends thereof, in order to conserve space.

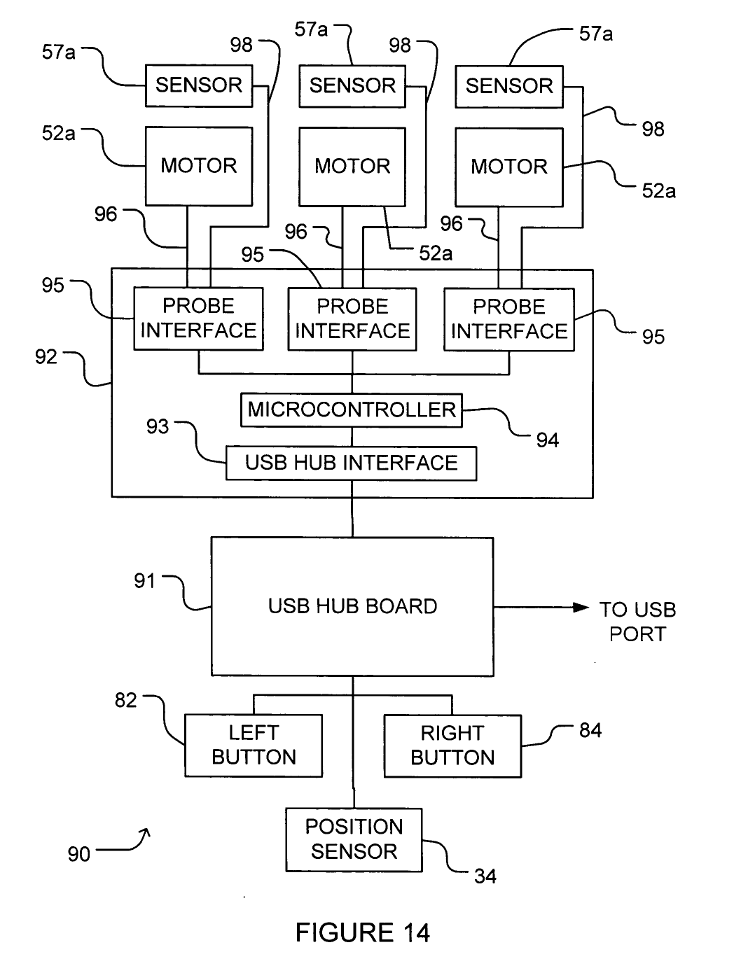

FIG. 14 shows a control system 90 which may be used to connect device 80 of FIG. 13 with a USB port of a computer system (not shown). Control system 90 comprises a USB hub board 91 for coordinating communication with the USB port of the computer system. USB hub board 91 is connected to receive the main position signal from position sensor 34, and signals from left and right buttons 82 and 84.

USB hub board 91 is also connected to a motor driver board 92. Motor driver board 92 comprises a USB interface 93 for communicating with USB hub board 91, a microcontroller 94, and probe interfaces 95 for interacting with probe members 36 (see FIG. 13). Each probe interface 95 is coupled to an associated motor 52a and quadrature sensor 57a by cables 96 and 98, respectively.

In a prototype embodiment, motor driver board 92 comprises the following components which provide the functionality listed thereunder:
PIC18F2550 Microcontroller
i. USB connectivity with PC
ii. Reads HEDS position sensors
iii. Generates ½ of Motor Control Signal
48 MHz Clock Source
i. Stable clock source for USB connectivity
3x Quad Half-H Bridges
i. Convert low amperage signals from PIC to drive high amperage motors
Hex Inverter
i. Inverts motor control signal from PIC to create second half of signal
NPN Transistor
i. Powers Quad Half-H Chips on signal from PIC
3x Status LEDs
i. Red indicates high current source connected
ii. Green indicates PIC status
iii. Amber indicates USB Power connected
3x Button Assembly Connectors
i. Motor Signal Out W0+, W0−, W1+W1−
ii. Sensor Signal In +5, GND, Enable, Q0, Q1
USB Header
i. Connects to dedicated USB cable from HUB
High Amperage Power Connector
i. Connects to external 5v power supply

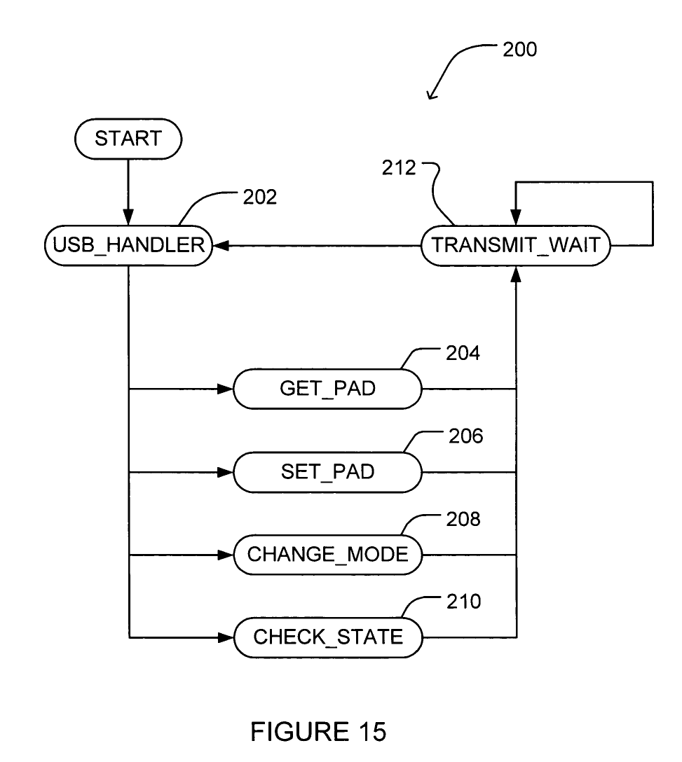

Microcontroller 94 comprises a processor, and is programmed with firmware for controlling the operation of the processor. The firmware may comprise a program which comprises USB Core code, Motor Driver code, and Quadrature Sensor code. The operation of the firmware program may be modeled as a state machine 200 as shown in FIG. 15.

The USB Core code provides the low level USB routines. The USB core is set up as a cooperative multi-tasking system, and as such, no USB specific calls interfere with one another. To ease integration of device 80 with the computer system to which it is connected, device 80 may be set up as a Comm-Port Descriptor Class (CDC) device. When connected to a computer system, a CDC device identifies itself as Comm-Port emulating device, and the computer system uses its own drivers to set up a virtual Comm-Port. In this way, a regular serial connection can be tunneled over the USB system. This negates the need for extra device drivers on the computer system. Applications running on the computer system need only open a regular connection to the identified Comm-Port and begin communication.

The Motor Driver code defines which pins of microcontroller 94 are used to interact with the hardware of motor 52a through probe interface 95, and provides the functions to power up motor 52a hardware, enable the motor hardware output, and update the motor positions (and thereby the probe member positions). The motor positions may be controlled by three variables for each motor: the current position, the current motor state, and the target position. When a motor update routine is called, the current position is compared with the target position, and if they differ (outside of a predetermined tolerance), then the current motor state is used to determine what the next motor state should be and motors 52a are moved one step towards the target position. The current position may be determined by monitoring motion signals from the quadrature sensor. The current position may be determined using all motion signals received since the last time the current position was determined, or since device 80 was calibrated. The current motor state may be set by controlling the current provided to the windings of motors 52a, and may be monitored by checking the most recent sequence of the quadrature signals received from quadrrature sensor 57a, as described below. The target position may be set by the software running on the computer.

The motor state indicates which direction the current is running through the two windings of the motor. Picking one direction arbitrarily as forward and labeling it as 1 and the other direction as backwards and labeling it as 0, the states are 00, 01, 11, 10. Cycling through this sequence in the direction of 00->01 (wrapping from 10 to 00) will cause the motor to rotate in one direction. Using this sequence going in the direction of 01->00 will cause the motor to rotate in the other direction.

The Quadrature Sensor code defines which pins of microcontroller 94 are used to read the quadrature signals from each of the quadrature sensors 57a, and the functions for reading and decoding the signals. Each quadrature sensor 57a may supply two lines of data. The two bits, one from each line, are read in and packed together into one byte for each sensor. The current byte is compared to the previous byte and a change in position is derived. When code wheel 58a is rotated under quadrature sensor 57a, the two signal lines will behave in the same manner as the motor state above. When rotating in one direction the lines will go through the sequence 00, 01, 11, 10. When rotating in the other direction the lines will go through the sequence 10, 11, 01, 00.

FIG. 15 illustrates an abstract state machine 200 which may control the operation of the firmware. State machine 200 comprises USB_HANDLER state 202, GET_PAD state 204, SET_PAD state 206, CHANGE_MODE state 208, CHECK_STATE state 210 and TRANSMIT_WAIT state 212. In USB_HANDLER state 202, microcontroller 94 checks for a packet of data from the computer system in a USB buffer. Data may be exchanged between the computer system and microcontroller 94, for example in eight byte packets, which is the minimum packet size allowed by the USB/CDC protocol.

Depending on the type of data has been received from the computer system, state machine 200 proceeds from USB_HANDLER state 202 to one of GET_PAD state 204, SET_PAD state 206, CHANGE_MODE state 208 and CHECK_STATE state 210 (which are collectively referred to as “pad handling states”). The type of data received from the computer system may be determined, for example, by header information of a received packet.

In GET_PAD state 204, microcontroller 94 determines the current position of pad 33 of a selected probe member 36 identified in the data received from the computer system, and creates a packet comprising the current position of pad 33 of the selected probe member 36. In SET_PAD state 206, microcontroller 94 sets the target position of pad 33 of a selected probe member 36 identified in the data received from the computer system and calls the motor update routine to adjust the position of the selected probe member 36 to move pad 33 to the target position, and may also create a packet comprising an acknowledgment that the selected probe member 36 has been moved to the target position. In CHANGE_MODE state 208, microcontroller 94 changes the mode of operation of device 80, and may also create a packet comprising an acknowledgment that the mode has been changed. In CHECK_STATE state 210, microcontroller 94 creates a packet that sends the number of missed quadrature steps that the firmware has sensed, and is used by software on the computer system primarily as a check to ensure that the firmware is operational.

The modes of operation selected in CHANGE_MODE state 208 may include DRAW, TOUCH, MODIFY, NEUTRAL, and CALIBRATE. The NEUTRAL mode is functionally equivalent to the DRAW mode described above but the connector does not create a surface when device 80 is moved, and is included for software compatibility. The CALIBRATE mode allows the user to press pads 33 of probe members 36 to their lowest positions and microcontroller 94 sets the current position of pads 33 to zero.

After state machine 200 passes through one of the pad handling states, it switches to TRANSMIT_WAIT state 212. In TRANSMIT_WAIT state 212, microcontroller 94 checks to see if the USB bus is ready to transmit data. The USB bus which connects USB hub board 91 and the computer system is also used to transmit signals from position sensor 34 and left and right buttons 82 and 84 to the computer system. If the USB bus is ready to transmit data, microconrtoller 94 writes any packet created in one of the pad handling states to the USB buffer and then state machine 200 changes to USB_HANDLER state 202. Otherwise, it remains in TRANSMIT_WAIT state 212 until the USB bus is ready to transmit.

As will be apparent to those skilled in the art in the light of the foregoing disclosure, many alterations and modifications are possible in the practice of this invention without departing from the spirit or scope thereof. For example:
reference plane P_{ref} could be replaced with a reference surface which is non-planar;
reference plane P_{ref} could have a predetermined orientation with respect to the virtual object and/or display 22;
display 22 could comprise a conventional two-dimensional display or could comprise a three-dimensional display
the specific components used in the prototype embodiment could be replace with different components with similar functionality;
in some embodiments, the system could operate in only DRAW and TOUCH modes, and an existing virtual surface could be changed by deleting it and drawing a new one.
   Accordingly, the scope of the invention is to be construed in accordance with the substance defined by the following claims.

1. An apparatus for interacting with a computer system, the computer system comprising a processor connected to a memory, the apparatus comprising:
a body moveable by a user and having a position sensor therein for producing a main position signal;
a plurality of probe members connected to the body, each probe member moveable in at least one degree of freedom with respect to the body;
a plurality of transducers, each transducer coupled to one of the probe members for producing a probe motion signal representative of motion of the probe member;
a plurality of actuators, each actuator coupled to one of the probe members to selectively apply force to the probe member within the at least one degree of freedom;
a control system coupled to the position sensor, the transducers and the actuators for receiving the main position signal and the probe motion signals and interacting with the processor in order to produce control signals for controlling the force applied by the actuators to each of the probe members.

2. An apparatus according to claim 1 comprising a mode selector switch for selecting an operating mode of the apparatus.

3. An apparatus according to claim 1 wherein the body comprises a mouse.

4. An apparatus according to claim 1 wherein the body comprises a joysitck.

5. An apparatus according to claim 1 wherein each of the probe members is moveable in a vertical direction.

6. An apparatus according to claim 5 wherein each of the probe members comprises a vertical shaft slidably received in an arm extending outwardly from the body.

7. An apparatus according to claim 6 wherein the vertical shaft comprises a rack, and wherein each of the actuators comprises a rotary actuator coupled to drive a horizontal drive shaft having a pinion thereon, the pinion of the horizontal drive shaft being operatively coupled to the rack of the vertical shaft.

8. An apparatus according to claim 7 wherein each horizontal drive shaft has a code wheel attached thereto, and each transducer comprises a sensor for monitoring rotation of the code wheel.

9. An apparatus according to claim 5 wherein the actuators are configured to selectively apply upward force to each of the probe members, and the control system is configured to control an amount of upward force applied to each of the probe members by the actuators.

10. An apparatus according to claim 9 wherein the amount of force applied to each probe member is varied by controlling an amount of current provided to each actuator.

11. An apparatus according to claim 9 wherein the amount of force applied to each probe member is varied in a manner determined by a height of each probe member.

12. An apparatus according to claim 11 wherein the amount of force applied to each probe member comprises a constant amount when the probe member is below a target position received from the processor of the computer system

13. An apparatus according to claim 9 wherein each of the probe members comprises a finger loop near a top thereof, such that the user may raise the probe members.

14. An apparatus according to claim 9 wherein each of the probe members comprises a pressure switch near a top thereof, the pressure switch coupled to an associated actuator for reducing the upward force applied to the probe member by the actuator when a downward force applied by the user to the pressure switch exceeds a predetermined threshold.

15. An apparatus according to claim 7 wherein each of the rotary actuators comprises a torque sensor, the torque sensor configured to reduce the upward force applied to the probe member by the actuator when a downward force applied by the user to the probe member exceeds a predetermined threshold.

16. An apparatus according to claim 1 wherein the control system comprises a microcontroller having a memory with a computer readable program thereon for carrying out a method of controlling the probe members, the method comprising:
receiving a target position for a selected probe member from the processor of the computer system; and,
causing the actuator coupled to the selected probe member to move the selected probe member to the target position.

17. An apparatus according to claim 16 wherein each of the actuators comprises a stepper motor, and wherein causing the actuator coupled to the selected probe member to move the selected probe member to the target position comprises:
(a) receiving the probe motion signals from the transducer coupled to the selected probe member;
(b) determining a current position of the selected probe member from a previous position of the selected probe member and the probe motion signals;
(c) comparing the current position of the selected probe member to the target position;
(d) moving the selected probe member one step towards the target position; and,
(e) repeating steps (a) to (d) until the current position of the selected probe member is within a predetermined tolerance of the target position.

18. An apparatus according to claim 16 wherein the method further comprises sending an acknowledgment to the processor of the computer system once the probe members have been moved to the target positions.

19. An apparatus according to claim 1 wherein the control system comprises a microcontroller having a memory with a computer readable program thereon for carrying out a method of providing the processor of the computer system with a current position of each of the probe members, the method comprising:
receiving the probe motion signals from the transducers; and,
determining the current position of each of the probe members from a previous position of each of the probe members and the probe motion signals.

20. A method for drawing a surface with an apparatus according to claim 1 on a display coupled to the processor, the method comprising:
receiving a reference surface;
displaying a main pointer on the display at a location determined by the main position signal;
displaying a probe pointer on the display for each probe member at a location determined by the probe motion signals;
displaying a connector defined by a selected set of the probe pointers; and
drawing the surface by moving the connector in response to changes in the main position signal and the probe motion signals, the surface comprising an area swept out by the connector.

21. A method of providing tactile feedback to a user, with an apparatus according to claim 1, the tactile feedback relating to a surface displayed on a display coupled to the processor, the method comprising:
(a) receiving a reference surface;
(b) displaying a main pointer on the display at a location determined by the main position signal;
(c) displaying a probe pointer on the display for each probe member at a location determined by the probe position signals;
(d) receiving a selected surface;
(e) adjusting each of the probe members to a height above the flat surface proportional to a distance between the selected surface and the reference surface at a projection of the associated probe pointer;
(f) receiving motion signals from the position sensor and the transducers of the apparatus;
(g) updating the main pointer and probe pointers on the display in response to the motion signals received from the position sensor and the transducers; and,
(h) repeating steps (e) through (g).

22. A method for modifying a surface, with an apparatus according to claim 1, the surface displayed on a display coupled to the processor, the method comprising:
(a) receiving a reference surface;
(b) displaying a main pointer on the display at a location determined by the main position signal;
(c) displaying a probe pointer on the display for each probe member at a location determined by the probe position signals;
(d) receiving a selected surface;
(e) adjusting each of the probe members to a height above the flat surface proportional to a distance between the selected surface and the reference surface at a projection of the associated probe pointer;
(f) receiving motion signals from the position sensor and the transducers of the apparatus;
(g) updating the surface in response to the motion signals received from the position sensor and the transducers;
(h) updating the main pointer and probe pointers on the display in response to the motion signals received from the position sensor and the transducers; and,
(i) repeating steps (e) through (h).
